(19) United States
(12) Patent Application Publication
(10) Pub. No.: US 2026/0287089 A1
(43) Pub. Date: Sep. 24, 2026

(54) PIPELINE ACCESSORY

(71) Applicant: Robert Monroe Zehnder, Wasilla, AK (US)

(72) Inventor: Robert Monroe Zehnder, Wasilla, AK (US)

(21) Appl. No.: 19/548,383

(22) Filed: Feb. 24, 2026

Related U.S. Application Data
(60) Provisional application No. 63/774,462, filed on Mar. 19, 2025.

(51) Int. Cl. F16L 3/10; F16L 3/223

(52) U.S. Cl. CPC F16L 3/1058; F16L 3/2235

(57) ABSTRACT

A cable organization device for attaching to a structure. The device includes a frame component configured to fit onto the structure. The device further includes a plurality of dividers extending from the frame component, each having a hole. The dividers may define one or more spaces, each space of the one or more spaces configured to accept one or more cables. The device further includes a fastening band directed through the holes of the dividers and around a circumference of the structure, configured to fasten the frame component to the structure.

### CROSS-REFERENCE TO RELATED APPLICATIONS

This application is a non-provisional and claims benefit of U.S. Provisional Application No. 63/774,462 filed Mar. 19, 2025, the specification of which is incorporated herein in its entirety by reference.

### FIELD OF THE INVENTION

The present invention is directed to an auxiliary device for attachment to a pipe structure for efficient cable arrangement.

### BACKGROUND OF THE INVENTION

Pipelines that run above ground throughout and between cities and across oilfields in the US, Mexico and Canada serve as a useful defined path for various cables to be run. This allows for the efficient transmission of power, data, or any other electrical resource to be transferred along the same path as the fluid resources (i.e., water, gas, etc.) transported through the pipeline. However, when a company wants a new cable installed on a pipe, they must thread banding through the existing cables on the pipe. This is a painstakingly slow process, requiring teams of technicians to spend long periods of time applying new cables to a pipeline, accruing high labor costs. Furthermore, this method limits the number of configurations that cables can be applied to a pipeline or any similarly shaped structure. Thus, there exists a present need for an accessory device configured to be applied to a structure to allow for the efficient application of cables to said structure.

### BRIEF SUMMARY OF THE INVENTION

It is an objective of the present invention to provide systems and devices that allow for attachment to a pipe structure for efficient cable arrangement, as specified in the independent claims. Embodiments of the invention are given in the dependent claims. Embodiments of the present invention can be freely combined with each other if they are not mutually exclusive.

The present invention features a cable organization device for attaching to a structure. The device may comprise a frame component configured to fit onto the structure. The device may further comprise a plurality of dividers extending from the frame component, each comprising a hole. The dividers may define one or more spaces, each space of the one or more spaces configured to accept one or more cables. The device may further comprise a fastening band directed through the holes of the dividers and around a circumference of the structure, configured to fasten the frame component to the structure.

The present invention features a cable organization system. The system may comprise a pipe structure having a shape. The system may further comprise a frame component configured to fit onto the pipe structure. The system may further comprise a plurality of dividers extending from the frame component, each comprising a hole. The plurality of dividers may define one or more spaces, each space of the one or more spaces configured to accept one or more cables. The system may further comprise a fastening component directed through the plurality of holes of the plurality of dividers and around a circumference of the pipe structure, configured to fasten the frame component to the pipe structure. In some embodiments, the fastening component may comprise a steel band or a pipe clamp.

The present invention features a method for affixing a cable organization device to a structure. In some embodiments, the method may comprise providing the cable organization device. The device may comprise a frame component having a shape matching a partial outline of the structure. The device may further comprise a plurality of dividers extending from the frame component, each comprising a hole disposed at the proximal end. The plurality of dividers may define one or more spaces. The device may further comprise a fastening component directed through the plurality of holes of the plurality of dividers. The method may further comprise fitting the frame component around the structure. The method may further comprise directing the fastening component around a circumference of the structure such that the frame component is fastened to the structure. The method may further comprise directing one or more cables through at least one of the one or more spaces defined by the plurality of dividers. In some embodiments, the fastening component may comprise a steel band or a pipe clamp.

One of the unique and inventive technical features of the present invention is the implementation of a cable organization attachment device configured to be attached to a pre-existing structure by a fastening component, such as a steel band or a pipe clamp. Without wishing to limit the invention to any theory or mechanism, it is believed that the technical feature of the present invention advantageously provides for efficient and low-cost cable layering of cables on a pipeline or any other structure while reducing labor time and risk of employee injuries. This satisfies a long-felt but unmet need for efficient, quick, and optionally removable attachment of a cable organization device to a pre-existing pipeline. None of the presently known prior references or works have the unique inventive technical feature of the present invention.

Another one of the unique and inventive technical features of the present invention is the implementation of a cable organization and directing device creating a separation between the cables and the pipeline. Without wishing to limit the invention to any theory or mechanism, it is believed that the technical feature of the present invention advantageously provides for a cable routing system for pipelines that accounts for fluctuations in pipe diameter and/or length over time. This also allows for safer and more efficient device installation. None of the presently known prior references or works have the unique inventive technical feature of the present invention.

Furthermore, the inventive technical feature of the present invention is counterintuitive. The reason that it is counterintuitive is because it contributed to a surprising result. One of ordinary skill in the art would expect that the use of pipe fastening components in general would cause damage to cables and pipes during size fluctuations. Surprisingly, the present invention implements steel bands and/or pipe clamps to couple the cable organization device to the structure instead of the cables themselves. The implementation of a floating system resulted in greater flexibility and a reduction in adverse effects as a result of pipeline diameter fluctuations. Thus, the inventive technical feature of the present invention contributed to a surprising result.

Any feature or combination of features described herein are included within the scope of the present invention provided that the features included in any such combination are not mutually inconsistent as will be apparent from the context, this specification, and the knowledge of one of ordinary skills in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a schematic diagram of a cable organization device of the present invention.

FIG. 1B shows a schematic diagram of an alternate embodiment of the cable organization device of the present invention.

FIG. 1C shows a schematic diagram of a cable organization system of the present invention.

FIG. 1D shows a schematic diagram of an alternate embodiment of the cable organization system of the present invention, implementing a pipe clamp for affixing the device to the pipe.

FIG. 2 shows an engineering diagram of the cable organization device of the present invention.

FIGS. 3A-3B show photographs of the cable organization device of the present invention.

FIGS. 4A-4D show photographs of various embodiments of the cable organization system of the present invention.

FIGS. 5A-5F show photographs of various embodiments of an alternate embodiment of the cable organization device and system of the present invention.

FIGS. 6A-6B show images of a slack spacing embodiment of the cable organization device of the present invention with spacing functionality for removing tension from cables. This embodiment of the device of the present invention may be interdigitated between other embodiments of the device along a structure to release tension on cables.

FIG. 7 shows a flowchart diagram for affixing a cable organization device of the present invention to a structure (e.g., a pipeline).

FIG. 8A-8B show alternate embodiments of the cable organization device of the present invention.

FIG. 9 shows an embodiments of the cable organization device having a pipe clamp for fastening to a structure.

### DETAILED DESCRIPTION OF THE INVENTION

Following is a list of elements corresponding to a particular element referred to herein:
1 structure
100 device
110 frame component
120 dividers
125 proximal hole
126 distal hole
130 fastening band
135 auxiliary band
200 slack storage device (angled)
300 slack storage device (straight)
310 slack upper frame
315 slack lower frame
320 slack bookends
325 proximal hole
326 distal hole
1000 system

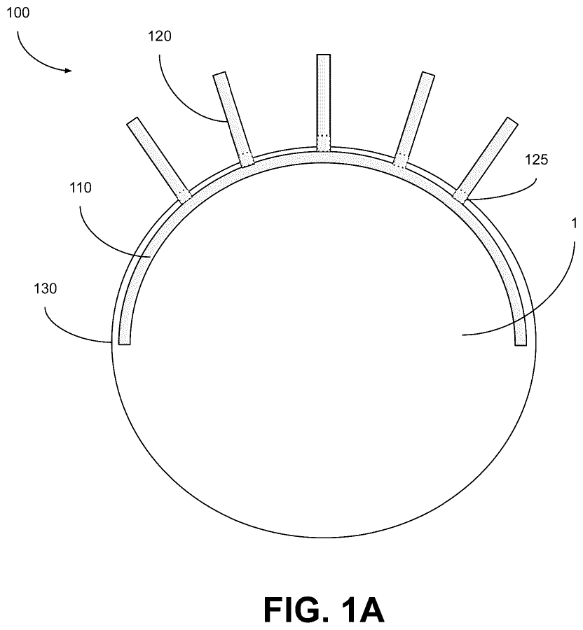

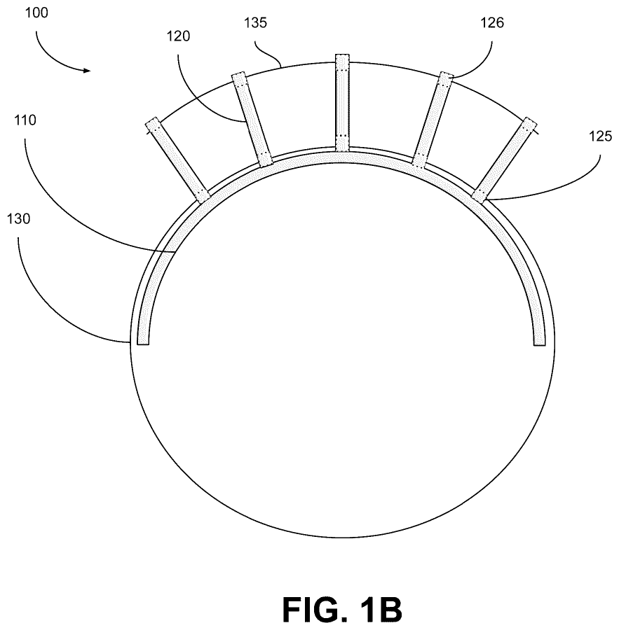

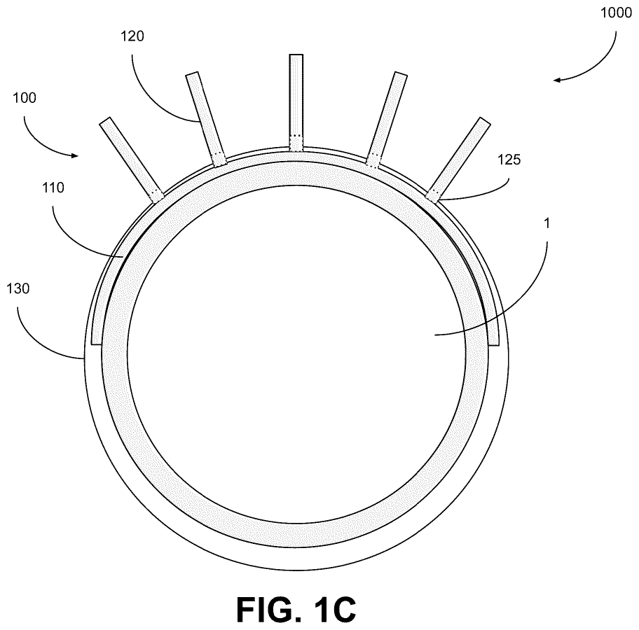

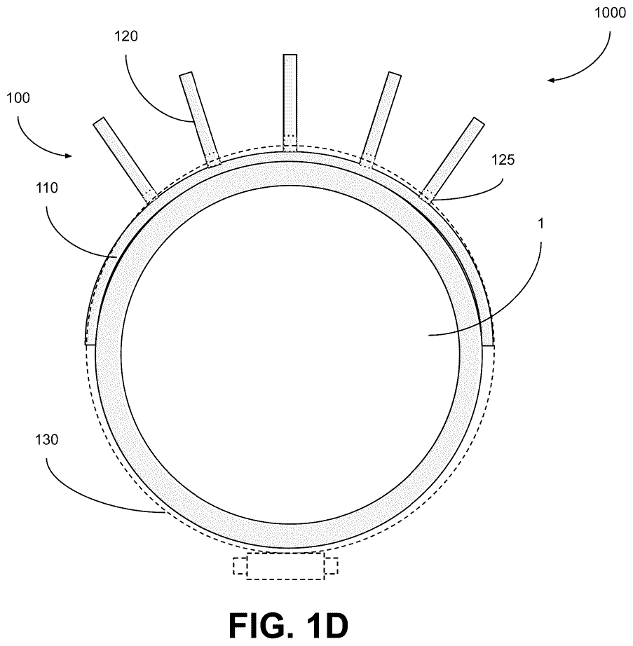

Referring now to FIGS. 1A-1B, the present invention features a cable organization device (100) for attaching to a structure (1). In some embodiments, the cable organization device (100) may comprise a frame component (110) having a shape matching a partial outline of the structure (1) such that the frame component (110) is configured to fit onto the structure (1). The cable organization device (100) may further comprise a plurality of dividers (120) extending from the frame component (110), each divider comprising a proximal end, a distal end, and a proximal hole (125) disposed at the proximal end. The plurality of dividers (120) may define one or more spaces, each space of the one or more spaces configured to accept one or more cables. The cable organization device (100) may further comprise a fastening component (130) directed through the plurality of proximal holes of the plurality of dividers (120) and around a circumference of the structure (1), configured to fasten the frame component (110) to the structure (1).

In some embodiments, the fastening component (130) may comprise a flexible steel band. In some embodiments, the fastening component (130) may comprise a pipe clamp. In some embodiments, each divider of the plurality of dividers (120) may further comprise a distal hole (126) disposed at the distal end. In some embodiments, the cable organization device (100) may further comprise an auxiliary band (135) directed through the plurality of distal holes of the plurality of dividers (120) and around the circumference of the structure (1), configured to further fasten the frame component (110) to the structure (1). In some embodiments, the structure (1) may comprise a cylindrical pipe such that the shape of the partial outline of the structure (1) comprises a semi-circular shape. In some embodiments, the structure (1) may comprise a rectangular structure such that the shape of the partial outline of the structure (1) comprises a partial rectangle shape. In some embodiments, the plurality of dividers (120) may arranged in a line having a first end, a second end, and a center point such that the plurality of dividers (120) comprise a first end divider at the first end of the line and a second end divider at the second end of the line, wherein the first end divider and the second end divider each comprise a bend such that the distal end of the first end divider and the distal end of the second end divider each angle towards the center point.

Referring now to FIGS. 1C-1D, the present invention features a cable organization system (1000). The cable organization system (1000) may comprise a pipe structure (1) having a shape. The cable organization system (1000) may further comprise one or more cable organization devices. Each cable organization device (100) may comprise a frame component (110) having a shape matching a partial outline of the shape of the pipe structure (1) such that the frame component (110) is configured to fit onto the pipe structure (1). Each cable organization device (100) may further comprise a plurality of dividers (120) extending from the frame component (110), each divider comprising a proximal end, a distal end, and a proximal hole (125) disposed at the proximal end. The plurality of dividers (120) may define one or more spaces, each space of the one or more spaces configured to accept one or more cables. Each cable organization device (100) may further comprise a fastening component (130) directed through the plurality of proximal holes of the plurality of dividers (120) and around a circumference of the pipe structure (1), configured to fasten the frame component (110) to the pipe structure (1).

In some embodiments, the fastening component (130) may comprise a flexible steel band. In some embodiments, the fastening component (130) may comprise a pipe clamp. In some embodiments, each divider of the plurality of dividers (120) may further comprise a distal hole (126) disposed at the distal end. In some embodiments, each cable organization device (100) may further comprise an auxiliary band (135) directed through the plurality of distal holes of the plurality of dividers (120) and around the circumference of the pipe structure (1), configured to further fasten the frame component (110) to the pipe structure (1). The pipe clamp may be compatible with all embodiments (e.g., standard and slack storage) of the cable organization device disclosed herein.

In some embodiments, the pipe structure (1) may comprise a cylindrical pipe such that the shape of the partial outline of the pipe structure (1) comprises a semi-circular shape. In some embodiments, the pipe structure (1) may comprise a rectangular structure such that the shape of the partial outline of the pipe structure (1) comprises a partial rectangle shape. In some embodiments, the plurality of dividers (120) may be arranged in a line having a first end, a second end, and a center point such that the plurality of dividers (120) comprise a first end divider at the first end of the line and a second end divider at the second end of the line. The first end divider and the second end divider may each comprise a bend such that the distal end of the first end divider and the distal end of the second end divider each angle towards the center point.

In some embodiments, the cable organization system (1000) may further comprise one or more slack storage devices alternately disposed between the one or more cable organization devices. Each slack storage device (300) may comprise a slack lower frame (315) having a shape matching a partial outline of the structure (1), comprising one or more proximal holes (325). The slack lower frame (315) may be affixed to the structure (1) by a slack storage device fastening component (130) directed through the one or more proximal holes (325). Each slack storage device (300) may further comprise a slack upper frame (310) operatively coupled to the slack lower frame (315), the slack upper frame (310) having a first end, a second end, and a flat surface extending between the first end and the second end. Each slack storage device (300) may further comprise a pair of slack bookends (320) extending from the first end and the second end of the slack upper frame (310), perpendicular to the flat surface, each slack bookend (320) comprising a distal hole disposed at a distal end of the slack bookend (320). The slack storage device may comprise a straight embodiment (300) with perpendicular bookends extending from the frame, and an angled embodiment (200) with angled bookends extending from the frame.

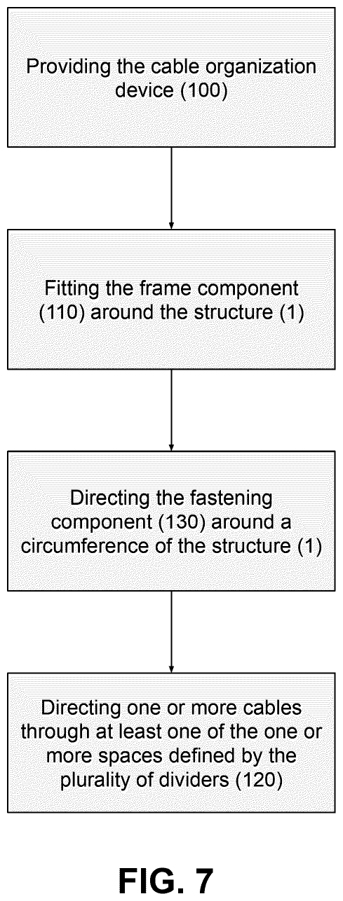

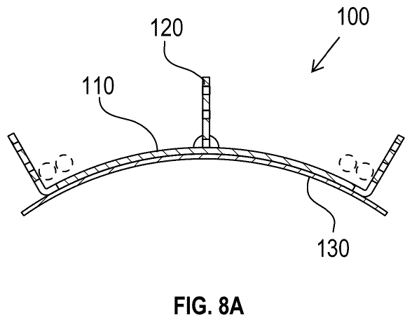

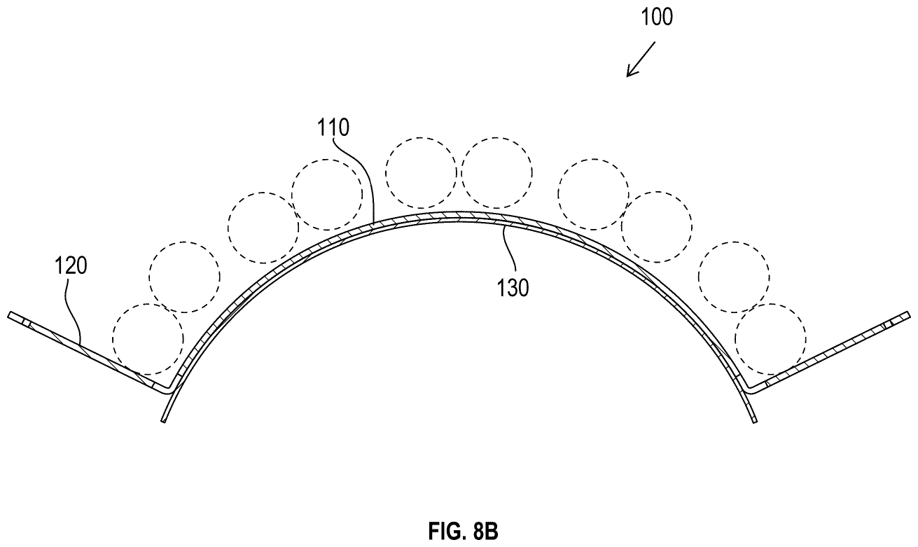

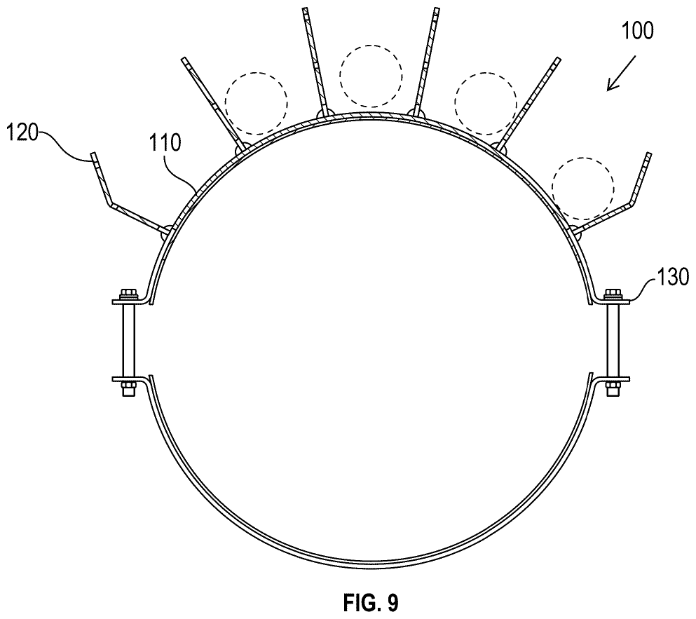

Referring now to FIG. 7, the present invention features a method for affixing a cable organization device (100) to a structure (1). The method may comprise providing the cable organization device (100), as described above. The cable organization device (100) may comprise a frame component (110) having a shape matching a partial outline of the structure (1), a plurality of dividers (120) extending from the frame component (110), each divider comprising a proximal end, a distal end, and a proximal hole (125) disposed at the proximal end defining one or more spaces, and a fastening component (130) directed through the plurality of proximal holes of the plurality of dividers (120). The method may further comprise fitting the frame component (110) around the structure (1). The method may further comprise directing the fastening component (130) around a circumference of the structure (1) such that the frame component (110) is fastened to the structure (1). The method may further comprise directing one or more cables through at least one of the one or more spaces defined by the plurality of dividers (120).

Each divider of the plurality of dividers (120) may further comprise a distal hole (126) disposed at the distal end. The method may further comprise directing an auxiliary band (135) through the plurality of distal holes of the plurality of dividers (120) and around the circumference of the structure (1) to further fasten the frame component (110) to the structure (1).

The present invention features a cable organization device (100) for attaching to a structure (1). In some embodiments, the device (100) may comprise a frame component (110) having a shape matching a partial outline of the structure (1) such that the frame component (110) is configured to fit onto the structure (1). The device (100) may further comprise a plurality of dividers (120) extending from the frame component (110), each divider comprising a proximal end, a distal end, and a proximal hole (125) disposed at the proximal end. The plurality of dividers (120) may define one or more spaces, each space of the one or more spaces configured to accept one or more cables. The device (100) may further comprise a fastening band (130) directed through the plurality of proximal holes of the plurality of dividers (120) and around a circumference of the structure (1), configured to fasten the frame component (110) to the structure (1).

In some embodiments, the frame component (110) may comprise a steel strip. In some embodiments, the frame component (110) may further comprise a rubber coating layered over the steel strip. In some embodiments, each divider of the plurality of dividers (120) may comprise a steel strip and a rubber coating layered over the steel strip. In some embodiments, the fastening band (130) may comprise a flexible steel band. In some embodiments, each divider of the plurality of dividers (120) may further comprise a distal hole (126) disposed at the distal end. In some embodiments, the device (100) may further comprise an auxiliary band (135) directed through the plurality of distal holes of the plurality of dividers (120) and around the circumference of the structure (1), configured to further fasten the frame component (110) to the structure (1). In some embodiments, the structure (1) may comprise a cylindrical pipe such that the shape of the partial outline of the structure (1) comprises a semi-circular shape. In some embodiments, the structure (1) may comprise a rectangular structure such that the shape of the partial outline of the structure (1) comprises a partial rectangle shape. In some embodiments, the plurality of dividers (120) may be arranged in a line having a first end, a second end, and a center point such that the plurality of dividers (120) comprise a first end divider at the first end of the line and a second end divider at the second end of the line. The first end divider and the second end divider may each comprise a bend such that the distal end of the first end divider and the distal end of the second end divider each angle towards the center point.

Referring now to FIG. 1B, the present invention features a cable organization device (100) for attaching to a structure (1). In some embodiments, the device (100) may comprise a frame component (110) comprising a steel strip having a shape matching a partial outline of the structure (1) such that the frame component (110) is configured to fit onto the structure (1) and a rubber coating layered over the steel strip. The device (100) may further comprise a plurality of dividers (120) extending from the frame component (110), each divider comprising a steel strip having a proximal end, a distal end, a proximal hole (125) disposed at the proximal end, and a distal hole (126) disposed at the distal end, and a rubber coating layered over the steel strip. The plurality of dividers (120) may define one or more spaces, each space of the one or more spaces configured to accept one or more cables. The device (100) may further comprise a fastening band (130) directed through the plurality of proximal holes of the plurality of dividers (120) and around a circumference of the structure (1), configured to fasten the frame component (110) to the structure (1). The device (100) may further comprise an auxiliary band (135) directed through the plurality of distal holes of the plurality of dividers (120) and around the circumference of the structure (1), configured to secure the plurality of dividers (120). It should be noted that the auxiliary band (135) does not go all the way around the pipe, it is just through and between the vertical dividers and terminates on the two outside verticals.

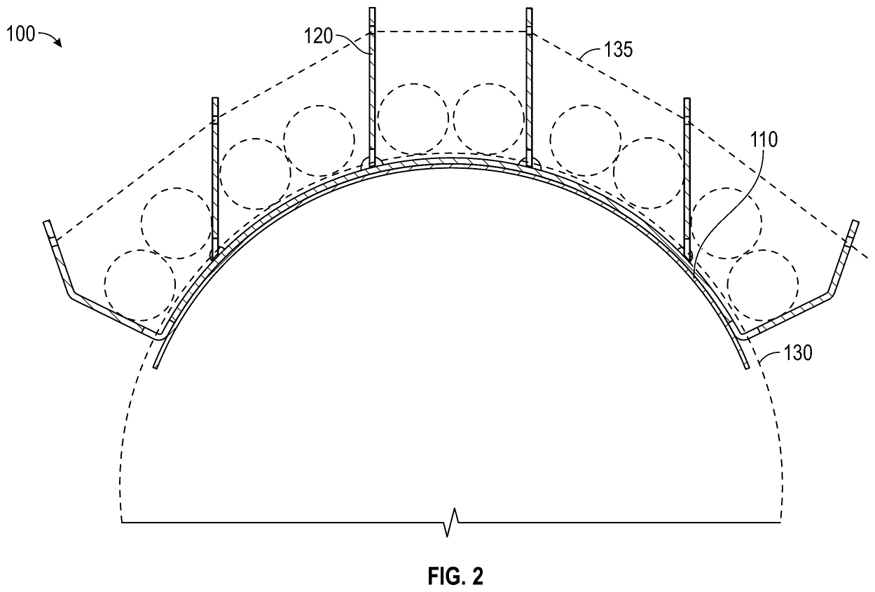

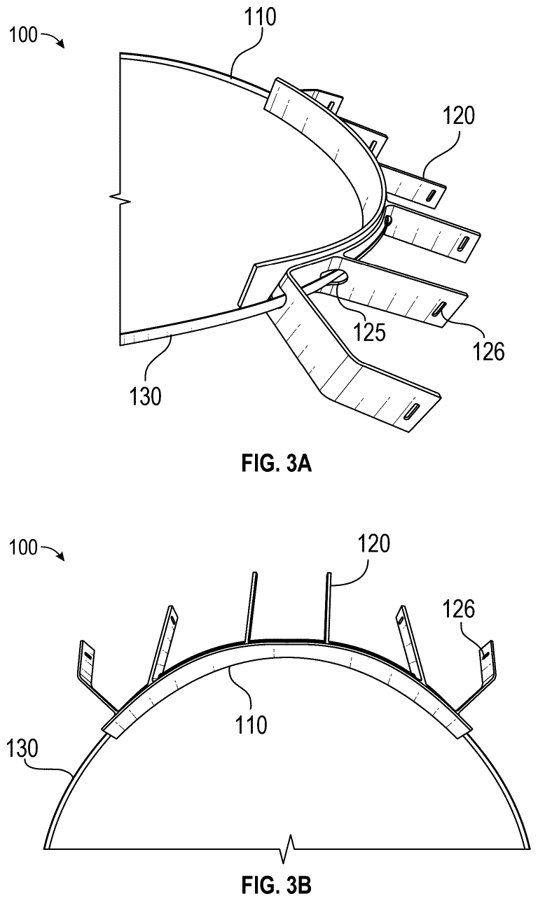

In some embodiments, the fastening band (130) may comprise a flexible steel band. In some embodiments, the auxiliary band (135) may comprise a flexible steel band. In some embodiments, the structure (1) may comprise a cylindrical pipe such that the shape of the partial outline of the structure (1) comprises a semi-circular shape. In some embodiments, the structure (1) may comprise a rectangular structure such that the shape of the partial outline of the structure (1) comprises a partial rectangle shape. In some embodiments, the plurality of dividers (120) may be arranged in a line having a first end, a second end, and a center point such that the plurality of dividers (120) comprise a first end divider at the first end of the line and a second end divider at the second end of the line. The first end divider and the second end divider may each comprise a bend such that the distal end of the first end divider and the distal end of the second end divider each angle towards the center point. Additional embodiments of the cable organization device (100) are depicted in FIGS. 2 and 3A-3B.

The present invention features a cable organization system (1000). In some embodiments, the system (1000) may comprise a pipe structure (1) having a shape. The system (1000) may further comprise a frame component (110) having a shape matching a partial outline of the shape of the pipe structure (1) such that the frame component (110) is configured to fit onto the pipe structure (1). The system (1000) may further comprise a plurality of dividers (120) extending from the frame component (110), each divider comprising a proximal end, a distal end, and a proximal hole (125) disposed at the proximal end. The plurality of dividers (120) may define one or more spaces, each space of the one or more spaces configured to accept one or more cables. The system (1000) may further comprise a fastening band (130) directed through the plurality of proximal holes of the plurality of dividers (120) and around a circumference of the pipe structure (1), configured to fasten the frame component (110) to the pipe structure (1).

In some embodiments, the frame component (110) may comprise a steel strip. In some embodiments, the frame component (110) may further comprise a rubber coating layered over the steel strip. In some embodiments, each divider of the plurality of dividers (120) may comprise a steel strip and a rubber coating layered over the steel strip. In some embodiments, the fastening band (130) may comprise a flexible steel band. In some embodiments, each divider of the plurality of dividers (120) may further comprise a distal hole (126) disposed at the distal end. In some embodiments, the system (1000) may further comprise an auxiliary band (135) directed through the plurality of distal holes of the plurality of dividers (120) and around the circumference of the pipe structure (1), configured to further fasten the frame component (110) to the pipe structure (1).

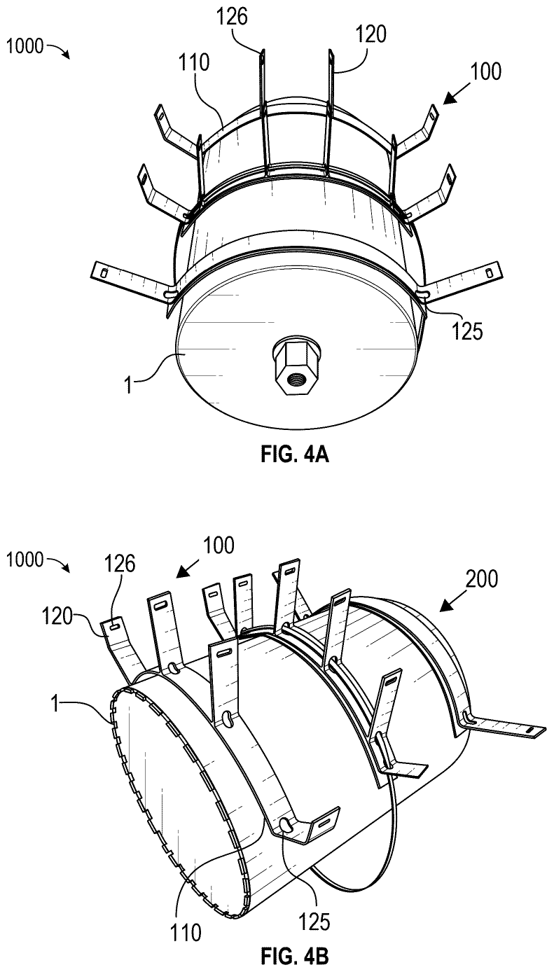

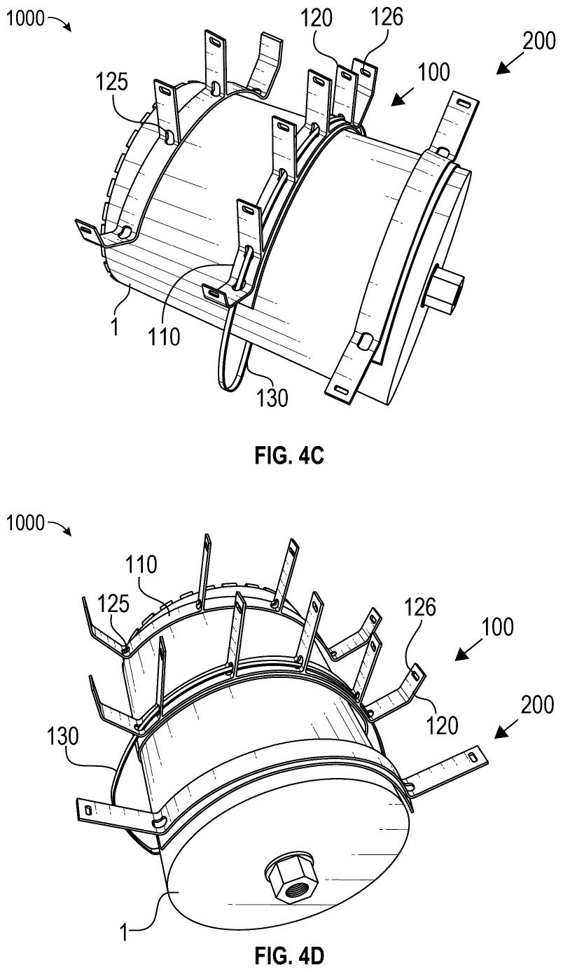

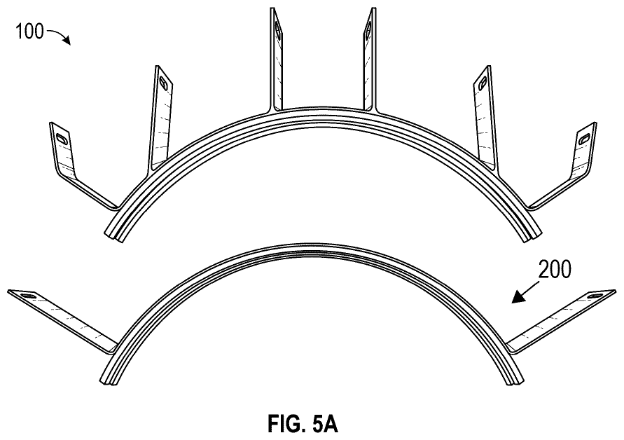

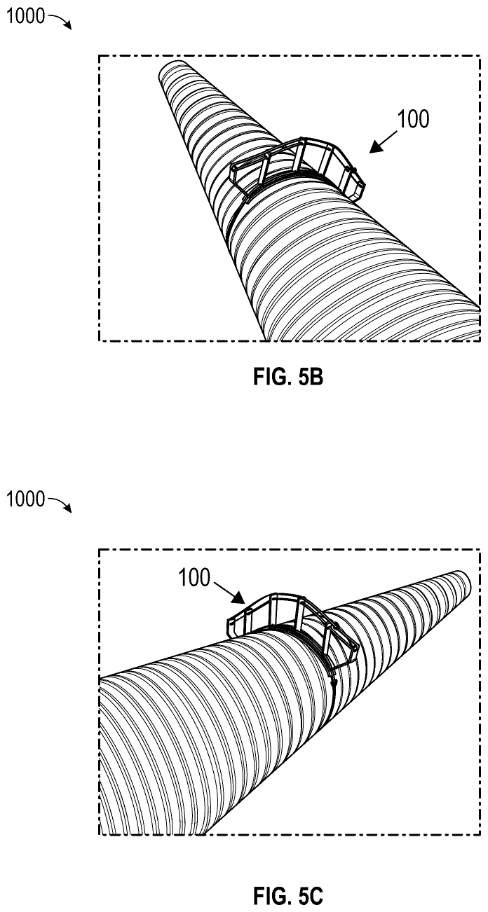

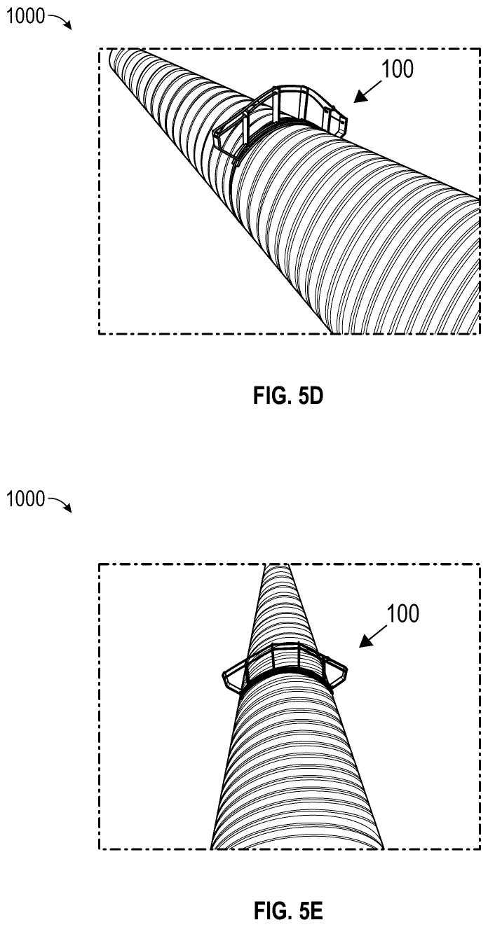

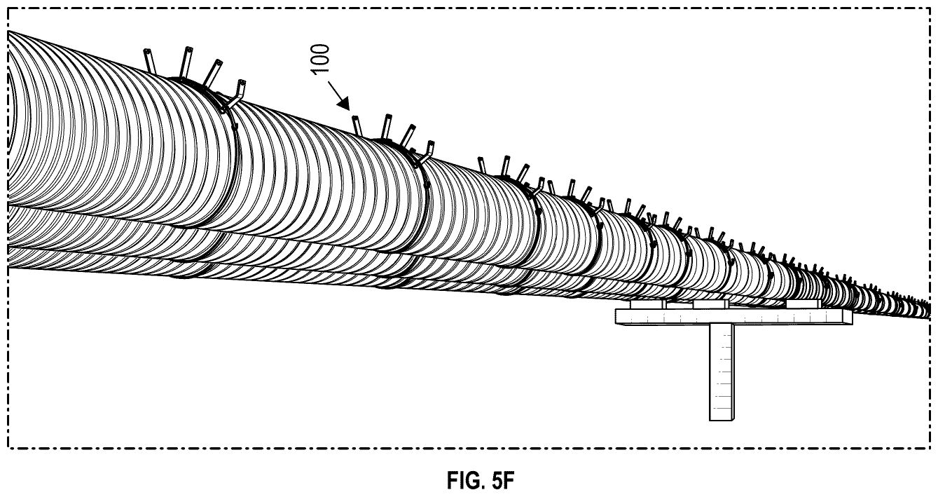

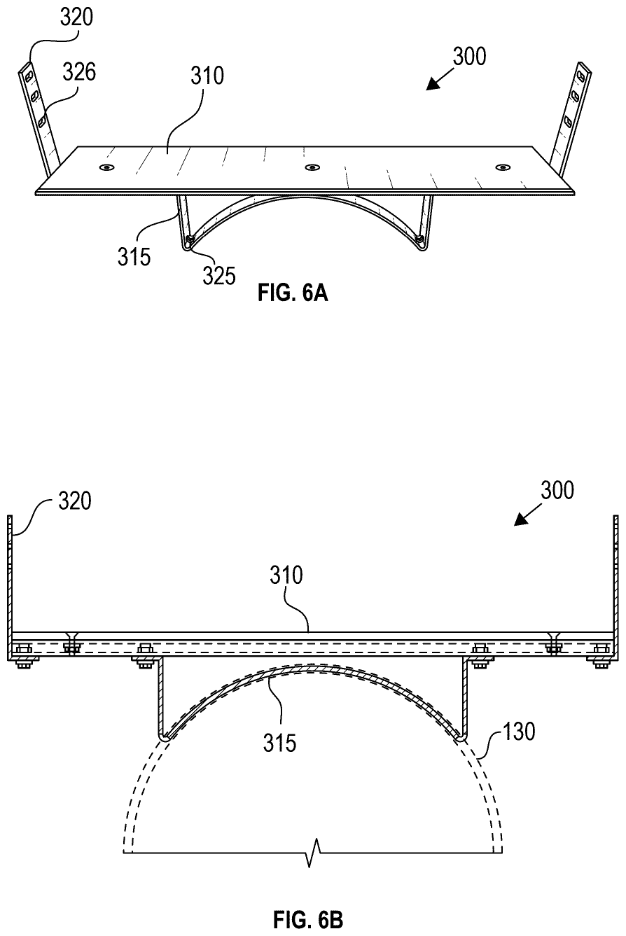

In some embodiments, the pipe structure (1) may comprise a cylindrical pipe such that the shape of the partial outline of the pipe structure (1) comprises a semi-circular shape. In some embodiments, the pipe structure (1) may comprise a rectangular structure such that the shape of the partial outline of the pipe structure (1) comprises a partial rectangle shape. In some embodiments, the plurality of dividers (120) may be arranged in a line having a first end, a second end, and a center point such that the plurality of dividers (120) comprise a first end divider at the first end of the line and a second end divider at the second end of the line. The first end divider and the second end divider may each comprise a bend such that the distal end of the first end divider and the distal end of the second end divider each angle towards the center point. Additional embodiments of the cable organization system (1000) of the present invention are depicted in FIGS. 4A-4D.

The present invention features a method for affixing a cable organization device (100) to a structure. In some embodiments, the method may comprise providing the cable organization device (100). The device (100) may comprise a frame component (110) having a shape matching a partial outline of the structure (1). The device (100) may further comprise a plurality of dividers (120) extending from the frame component (110), each divider comprising a proximal end, a distal end, and a proximal hole (125) disposed at the proximal end. The plurality of dividers (120) may define one or more spaces. The device (100) may further comprise a fastening band (130) directed through the plurality of proximal holes of the plurality of dividers (120). The method may further comprise fitting the frame component (110) around the structure (1). The method may further comprise directing the fastening band (130) around a circumference of the structure (1) such that the frame component (110) is fastened to the structure (1). The method may further comprise directing one or more cables through at least one of the one or more spaces defined by the plurality of dividers (120).

In some embodiments, each divider of the plurality of dividers (120) may further comprise a distal hole (126) disposed at the distal end. In some embodiments, the method may further comprise directing an auxiliary band (135) through the plurality of distal holes of the plurality of dividers (120) and around the circumference of the structure (1) to further fasten the frame component (110) to the structure (1). In some embodiments, the structure (1) may comprise a cylindrical pipe such that the shape of the partial outline of the structure (1) comprises a semi-circular shape. In some embodiments, the structure (1) may comprise a rectangular structure such that the shape of the partial outline of the structure (1) comprises a partial rectangle shape. In some embodiments, the plurality of dividers (120) may be arranged in a line having a first end, a second end, and a center point such that the plurality of dividers (120) comprise a first end divider at the first end of the line and a second end divider at the second end of the line. The first end divider and the second end divider may each comprise a bend such that the distal end of the first end divider and the distal end of the second end divider each angle towards the center point.

### EMBODIMENTS

The following embodiments are intended to be illustrative only and not to be limiting in any way.
Embodiment 1: A cable organization device (100) for attaching to a structure (1), the device (100) comprising: a frame component (110) comprising a steel strip having a shape matching a partial outline of the structure (1) such that the frame component (110) is configured to fit onto the structure (1) and a rubber coating layered over the steel strip; a plurality of dividers (120) extending from the frame component (110), each divider comprising a steel strip having a proximal end, a distal end, a proximal hole (125) disposed at the proximal end, and a distal hole (126) disposed at the distal end, and a rubber coating layered over the steel strip; wherein the plurality of dividers (120) define one or more spaces, each space of the one or more spaces configured to accept one or more cables; a fastening band (130) directed through the plurality of proximal holes of the plurality of dividers (120) and around a circumference of the structure (1), configured to fasten the frame component (110) to the structure (1); and an additional band (135) directed through the plurality of distal holes of the plurality of dividers (120) and around the circumference of the structure (1), configured to further fasten the frame component (110) to the structure (1).
Embodiment 2: The device (100) of Embodiment 1, wherein the fastening band (130) comprises a flexible steel band.
Embodiment 3: The device (100) of Embodiment 1, wherein the additional band (135) comprises a flexible steel band.
Embodiment 4: The device (100) of Embodiment 1, wherein the structure (1) comprises a cylindrical pipe such that the shape of the partial outline of the structure (1) comprises a semi-circular shape.
Embodiment 5: The device (100) of Embodiment 1, wherein the structure (1) comprises a rectangular structure such that the shape of the partial outline of the structure (1) comprises a partial rectangle shape.
Embodiment 6: The device (100) of Embodiment 1, wherein the plurality of dividers (120) are arranged in a line having a first end, a second end, and a center point such that the plurality of dividers (120) comprise a first end divider at the first end of the line and a second end divider at the second end of the line, wherein the first end divider and the second end divider each comprise a bend such that the distal end of the first end divider and the distal end of the second end divider each angle towards the center point.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

Reference numbers recited herein, in the drawings, and in the claims are solely for ease of examination of this patent application and are exemplary. The reference numbers are not intended in any way to limit the scope of the claims to the particular features having the corresponding reference numbers in the drawings.

What is claimed is:

1) A cable organization device (100) for attaching to a structure (1), the device (100) comprising:
a) a frame component (110) having a shape matching a partial outline of the structure (1) such that the frame component (110) is configured to fit onto the structure (1);
b) a plurality of dividers (120) extending from the frame component (110), each divider comprising a proximal end, a distal end, and a proximal hole (125) disposed at the proximal end;
wherein the plurality of dividers (120) define one or more spaces, each space of the one or more spaces configured to accept one or more cables; and
c) a fastening component (130) directed through the plurality of proximal holes of the plurality of dividers (120) and around a circumference of the structure (1), configured to fasten the frame component (110) to the structure (1).

2) The device (100) of claim 1, wherein the fastening component (130) comprises a flexible steel band.

3) The device (100) of claim 1, wherein the fastening component (130) comprises a pipe clamp.

4) The device (100) of claim 1, wherein each divider of the plurality of dividers (120) further comprises a distal hole (126) disposed at the distal end.

5) The device (100) of claim 4 further comprising an auxiliary band (135) directed through the plurality of distal holes of the plurality of dividers (120) and around the circumference of the structure (1), configured to further fasten the frame component (110) to the structure (1).

6) The device (100) of claim 1, wherein the structure (1) comprises a cylindrical pipe such that the shape of the partial outline of the structure (1) comprises a semi-circular shape.

7) The device (100) of claim 1, wherein the structure (1) comprises a rectangular structure such that the shape of the partial outline of the structure (1) comprises a partial rectangle shape.

8) The device (100) of claim 1, wherein the plurality of dividers (120) are arranged in a line having a first end, a second end, and a center point such that the plurality of dividers (120) comprise a first end divider at the first end of the line and a second end divider at the second end of the line, wherein the first end divider and the second end divider each comprise a bend such that the distal end of the first end divider and the distal end of the second end divider each angle towards the center point.

9) A cable organization system (1000) comprising:
a) a pipe structure (1) having a shape; and
b) one or more cable organization devices, each cable organization device (100) comprising:
i) a frame component (110) having a shape matching a partial outline of the shape of the pipe structure (1) such that the frame component (110) is configured to fit onto the pipe structure (1);
ii) a plurality of dividers (120) extending from the frame component (110), each divider comprising a proximal end, a distal end, and a proximal hole (125) disposed at the proximal end;
wherein the plurality of dividers (120) define one or more spaces, each space of the one or more spaces configured to accept one or more cables; and
iii) a fastening component (130) directed through the plurality of proximal holes of the plurality of dividers (120) and around a circumference of the pipe structure (1), configured to fasten the frame component (110) to the pipe structure (1).

10. The system (1000) of claim 9, wherein the fastening component (130) comprises a flexible steel band.

11. The system (1000) of claim 9, wherein the fastening component (130) comprises a pipe clamp.

12. The system (1000) of claim 9, wherein each divider of the plurality of dividers (120) further comprises a distal hole (126) disposed at the distal end.

13. The system (1000) of claim 12, each cable organization device (100) further comprises an auxiliary band (135) directed through the plurality of distal holes of the plurality of dividers (120) and around the circumference of the pipe structure (1), configured to further fasten the frame component (110) to the pipe structure (1).

14. The system (1000) of claim 9, wherein the pipe structure (1) comprises a cylindrical pipe such that the shape of the partial outline of the pipe structure (1) comprises a semi-circular shape.

15. The system (1000) of claim 9, wherein the pipe structure (1) comprises a rectangular structure such that the shape of the partial outline of the pipe structure (1) comprises a partial rectangle shape.

16. The system (1000) of claim 9, wherein the plurality of dividers (120) are arranged in a line having a first end, a second end, and a center point such that the plurality of dividers (120) comprise a first end divider at the first end of the line and a second end divider at the second end of the line, wherein the first end divider and the second end divider each comprise a bend such that the distal end of the first end divider and the distal end of the second end divider each angle towards the center point.

17. The system (1000) of claim 9 further comprising one or more slack storage devices alternately disposed between the one or more cable organization devices, each slack storage device (300) comprising:
a) a slack lower frame (315) having a shape matching a partial outline of the structure (1), comprising one or more proximal holes (325);
wherein the slack lower frame (315) is affixed to the structure (1) by a slack storage device fastening component (130) directed through the one or more proximal holes (325);
b) a slack upper frame (310) operatively coupled to the slack lower frame (315), the slack upper frame (310) having a first end, a second end, and a flat surface extending between the first end and the second end; and
c) a pair of slack bookends (320) extending from the first end and the second end of the slack upper frame (310), perpendicular to the flat surface, each slack bookend (320) comprising a distal hole disposed at a distal end of the slack bookend (320).

18. A method for affixing a cable organization device (100) to a structure (1), the method comprising:
a) providing the cable organization device (100) comprising:
i) a frame component (110) having a shape matching a partial outline of the structure (1);
ii) a plurality of dividers (120) extending from the frame component (110), each divider comprising a proximal end, a distal end, and a proximal hole (125) disposed at the proximal end;
wherein the plurality of dividers (120) define one or more spaces; and
iii) a fastening component (130) directed through the plurality of proximal holes of the plurality of dividers (120);
b) fitting the frame component (110) around the structure (1);
c) directing the fastening component (130) around a circumference of the structure (1) such that the frame component (110) is fastened to the structure (1); and
d) directing one or more cables through at least one of the one or more spaces defined by the plurality of dividers (120).

19. The method of claim 18, wherein each divider of the plurality of dividers (120) further comprises a distal hole (126) disposed at the distal end.

20. The method of claim 19 further comprising directing an auxiliary band (135) through the plurality of distal holes of the plurality of dividers (120) and around the circumference of the structure (1) to further fasten the frame component (110) to the structure (1).
